(19) United States
(12) Patent Application Publication
(10) Pub. No.: US 2013/0051905 A1
(43) Pub. Date: Feb. 28, 2013

(54) FURNITURE ELEMENT AND METHOD OF MANUFACTURING

(71) Applicant: Benny Andersson, Almhult (SE)

(72) Inventor: Benny Andersson, Almhult (SE)

(73) Assignee: Inter IKEA Systems B.V. (NL), Delft (NL)

(21) Appl. No.: 13/579,509

(22) PCT Filed: Feb. 19, 2010
(86) PCT No.: PCT/EP2010/052135

§ 371 Date: Oct. 31, 2012

(51) Int. Cl. A47B 96/20; B23P 11/00

(52) U.S. Cl. 403/270; 29/525.01

(57) ABSTRACT

A furniture element (100) comprising a first sheet of board material (102), a second sheet of board material (104) arranged with the first sheet to form a structure of the furniture element, and a connective element (106) is disclosed. The connective element has at least a part thereof arranged between the first and second sheet material such that when, arranging the first sheet, the second sheet and the connective element, the first sheet, the second sheet and the connective element become integral parts of the furniture element, and the connective element is arranged to receive mating connective elements for connection of remote furniture elements. An automated method of manufacturing such a furniture element is also disclosed.

### TECHNICAL FIELD

The present invention relates to a furniture element. In particular, the invention relates to an element comprising board material and a connective element for connecting to remote furniture elements.

### BACKGROUND

Furniture has been made by joining elements, e.g. by gluing, nailing, screwing, etc. the elements together. This was long time a task for a craftsman. In the 1950's, IKEA involved the end user of furniture to assemble furniture, which put demands on elements to be more easily assembled, with limited set of, or no tools. This, and an idea of enabling the user to adapt the end product by assembling a selected set of elements to achieve functions demanded by the end user, put further demands on elements to be easily and flexibly assembled. There is therefore a need for a solution providing such features.

### SUMMARY

The present invention is based on the understanding that use of board materials can provide light, strong and versatile furniture products. The inventors have also found that board products put certain demands at connecting points, which here is solved by integrating a connective element to the board product. Here, integrating means that at least a part of the connective element is arranged between members of board material. The connective element has means to receive mating connective elements for connection of remote furniture elements, and thereby easy and flexible assembly is provided.

According to a first aspect, there is provided a furniture element comprising a first sheet of board material; a second sheet of board material arranged with the first sheet to form a structure of the furniture element, and a connective element having at least a part thereof arranged between the first and second sheet material. When arranging the first sheet, the second sheet and the connective element, the first sheet, the second sheet and the connective element become integral parts of the furniture element. The connective element is arranged to receive mating connective elements for connection of remote furniture elements.

The furniture element may further comprise a supporting structure arranged on one of said sheets by means of an adhesive, wherein said first and second sheets is formed from one sheet which is folded by one or more folds such that the supporting structure is enclosed at least partly within said sheets. The connective element may form at least a part of the supporting structure.

The one sheet may comprise a laminated board comprising a laminating foil, applied on a first side of a board material on which a first longitudinal groove on said first side of the board material is applied, such that at least one outer-pointing normal to the tangent plane of each groove surface of the first groove will intersect the plane of the first side of the board, and a second longitudinal groove on a second side of said board material is arranged, such that said second groove is extending through said board material to connect with said first groove, whereby a through slot is created in the board material, such that at least one outer-pointing normal to the tangent plane of each groove surface of said second groove will intersect the plane of the second side of the board, and the laminating foil covers said first groove, such that the one or more folds are along a set of such through slots. The supporting structure may comprise a longitudinal body at least along one edge of the furniture element. The longitudinal body may be the connective element.

The furniture element may further comprise a distance material arranged between the first and second sheets. The distance material may comprise honeycomb cardboard.

The first and second sheets may be adhered to each other along the edges thereof, and the cross-section of at least one of the sheets, in the normal to it, is provided with fluctuations, whereby a flexural rigidity of the furniture element is obtained. The connective element may be arranged along at least a part of one of the edges, and the part of the connective element which is arranged between the first and second sheets may also be adhered to the first and second sheets along the at least a part of the edge.

At least a part of the connective element may be arranged distant from any edge of the first or second sheet. The at least a part of the connective element arranged distant from any edge of the first or second sheet may also be arranged as a support between the first and second sheets.

The at least a part of the connective element arranged distant from any edge of the first or second sheet may be arranged to connect to a remote furniture element such that a force component in a direction normal or counter-normal to at least one of the sheets is taken by the connection.

At least a part of the connective element may be arranged at an edge of the furniture element. The at least a part of the connective element arranged at the edge of the furniture element may be arranged to connect to a remote furniture element such that a force component in a direction perpendicular to a normal or counter-normal to at least one of the sheets is taken by the connection.

The at least a part of the connective element arranged at the edge of the furniture element may be arranged to connect to a remote furniture element such that a force component in a direction normal or counter-normal to at least one of the sheets is taken by the connection.

The connective element may comprise any of a group comprising snap lock, bayonet lock, bolt receiver, and hook element.

According to a second aspect, there is provided a method of manufacturing a furniture element comprising providing a first sheet of board material to a line of production; providing on the first sheet, a connective element arranged to receive mating connective elements for connection of remote furniture elements; enclosing the at least a part of the connective element by a second sheet of board material such that the at least a part of the connective element is arranged between the first and second sheet material such that when, arranging the first sheet, the second sheet and the connective element, the first sheet, the second sheet and the connective element become integral parts of the furniture element.

The first and second sheets may be separate sheets.

The method may further comprise forming said first and second sheets from one sheet by folding by one or more folds such that the step of enclosing of the at least part of the connective element is achieved within said first and second sheets. The one sheet may comprise a laminated board, and the method may further comprise applying a first longitudinal groove on a first side of the board material such that at least one outer-pointing normal to the tangent plane of each groove surface of the first groove will intersect the plane of the first side of the board; applying a second longitudinal groove on a second side of said board material is arranged, such that said second groove is extending through said board material to connect with said first groove, whereby a through slot is created in the board material and, such that at least one outer-pointing normal to the tangent plane of each groove surface of said second groove will intersect the plane of the second side of the board; and applying a laminating foil on a first side of a board material such that the laminating foil covers said first groove, wherein the one or more folds are made along a set of such through slots.

The method may further comprise providing one or more members of a supporting structure arranged on said first sheet before said step of enclosing.

The method may further comprise adhering the connective element to the first and second sheets, respectively.

### BRIEF DESCRIPTION OF DRAWINGS

FIG. 1 is an exploded view of a furniture element according to an embodiment.

FIGS. 2a to 2f illustrates examples, respectively, of details of a connective element according to embodiments.

FIGS. 3a to 3f illustrates examples, respectively, of details of a connective element according to embodiments.

FIG. 4 illustrates an example of combinations of connections of a connective element according to an embodiment.

FIG. 5 illustrates an approach where sheets are formed from one sheet being folded.

FIG. 6 is an exploded view of a furniture element according to an embodiment.

FIGS. 7a and 7b illustrates details relevant to the embodiment of FIG. 6.

FIG. 8 is an exploded view of a furniture element according to an embodiment.

FIG. 9 schematically illustrates manufacturing of a furniture element according to an embodiment.

FIG. 10 schematically illustrates manufacturing of a furniture element according to an embodiment.

FIGS. 11 to 16 briefly illustrate a few of possible embodiments according to demonstrated principles.

FIG. 17 illustrates elements in exploded view of a furniture element to be manufactured according to the principle demonstrated with reference to FIG. 5.

FIG. 18 illustrates a use case where furniture elements are connected according to an embodiment.

FIG. 19 illustrates a detail of a connection, for example as of use case of FIG. 18, according to an embodiment.

FIGS. 20a to 20e illustrate a use case where furniture elements are connected to form a drawer according to an embodiment.

FIG. 21 illustrates a use case where furniture elements are connected to form a file cabinet according to an embodiment.

FIG. 22 illustrates a use case where a furniture element is connected to another furniture element, here a hook, adapted for direct connection according to an embodiment.

FIG. 23 illustrates a use case where a functional element is connected to a furniture element according to an embodiment.

FIGS. 24a to 24e illustrate a use case where a furniture element is connected to another furniture element, here a shelf, adapted for direct connection according to an embodiment.

### DETAILED DESCRIPTION

FIG. 1 is an exploded view of a furniture element 100 according to an embodiment. The furniture element comprises a first sheet of board material 102, a second sheet of board material 104 and a connective element 106. In this embodiment, the furniture element also comprises frame elements 108, which can be made of wood, chipboard, polymer, metal, etc. depending on the nature, desired features, and expression of the furniture element. The board material of the first and second sheets can be medium or high density fibreboard, which can be provided by for example a laminated surface element which will constitute an outer surface of the sheets in the final furniture element.

The second sheet 104 is arranged with the first sheet 102 to form a structure of the furniture element according to desired features, such as being rigid, having a desire shape, etc. The connective element 106 has at least a part thereof arranged between the first and second sheets 102, 104 such that when arranging the first sheet 102, the second sheet 104 and the connective element 106, the first sheet 102, the second sheet 104 and the connective element 106 become integral parts of the furniture element 100. The connection between the connective element 106 and the sheets 102, 104, respectively, can be achieved by an adhesive or welding.

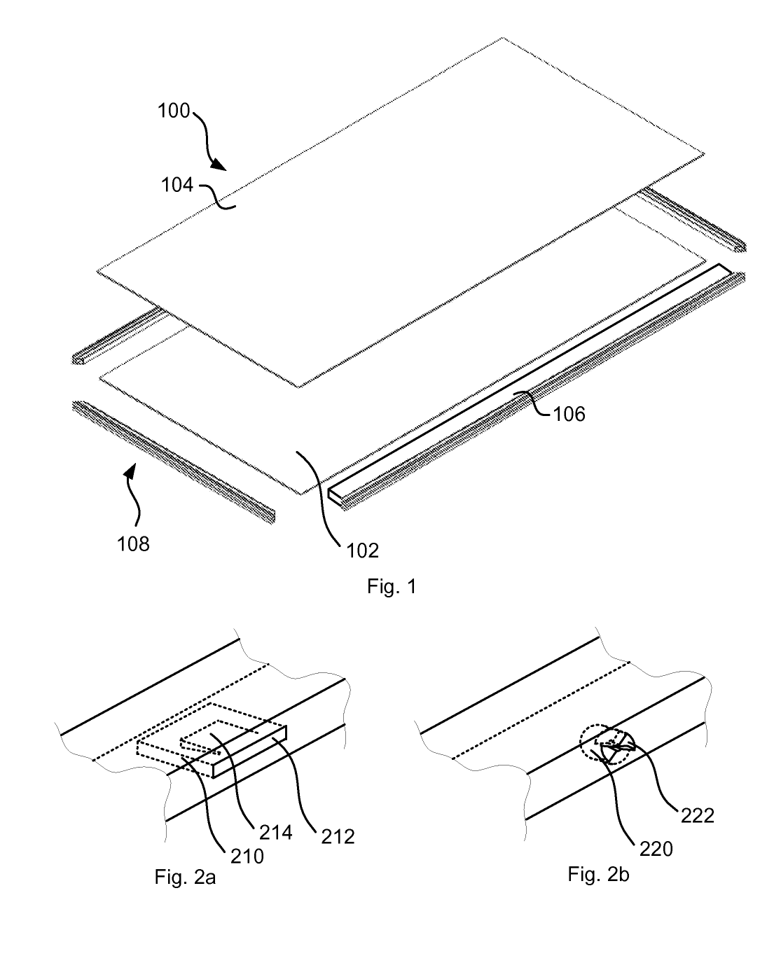

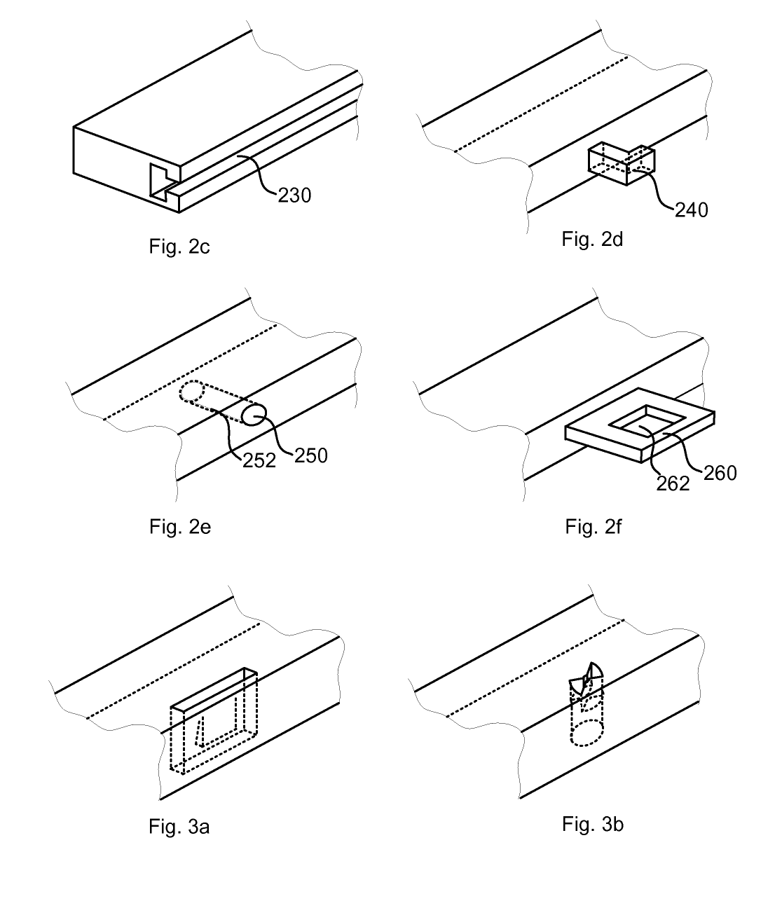

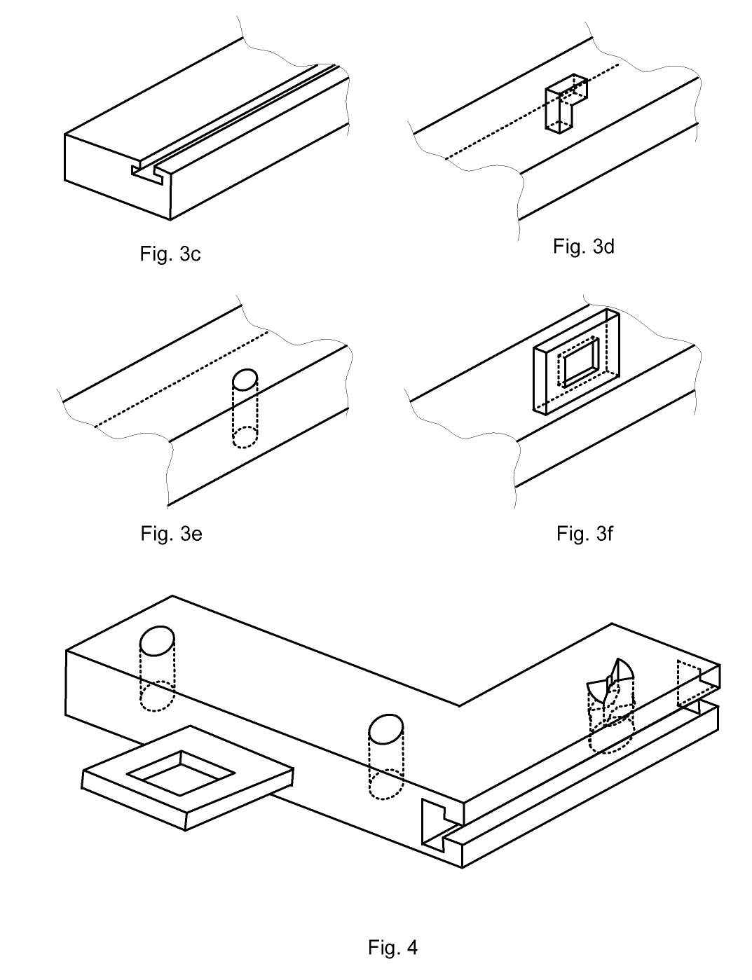

The connective element 106 is arranged to receive mating connective elements for connection of remote furniture elements. The remote furniture elements can be other furniture elements similar to the furniture element 100, legs, wall mounts, hinges, lighting equipment, cable guides, drawers, cabinets, decorative elements, etc. FIGS. 2 and 3 illustrate examples of connective features of the connective element 106. The illustrations view a small section of the connective element for illustrating the particular example of connection type, respectively. The connective element can comprise one or more connection types. Thus, the illustrated examples can be used in any combination to achieve the desired connecting features of the connective element 106 and thus for the furniture element. It should be noted that the connective element 106 can be one or more items of the furniture element 100, as will be shown explicitly for other embodiments, but is equally feasible for this embodiment.

FIG. 2a illustrates a snap lock 210 having a slot 212 in which a male member of a mating furniture element can be inserted. A resilient element 214 inside the snap lock 210 is arranged such that when the male member of the mating furniture is inserted into the slot 212, the resilient element 214 snaps into a recess of the male member and locks the male member in the snap lock 210.

Alternatively, the connective element comprises the male member and the mating furniture element has the snap lock, wherein the locking is performed similarly, as will be demonstrated with reference to FIG. 2f below.

FIG. 2b illustrates a bayonet lock 220 having a shaped opening 222 towards the exterior of the connective element. The bayonet lock 220 is arranged such that when a male member of the mating furniture element having a corresponding shape is inserted into the shaped opening 222 and is turned, e.g. a quarter turn, the male member locks into the bayonet lock 220. Alternatively, the male member is arranged on the connective element and the mating furniture element has the opening, but the locking is performed similarly.

FIG. 2c illustrates an elongated groove 230 in the connective element. The elongated groove 230 can have a T-shaped or L-shaped cross section such that a mating element can be slid, turned or snapped into the groove for locking in a direction extending from the groove 230. By tightening the mating element, the mating element can also be locked in the longitudinal direction of the groove 230. Alternatively, in stead of the elongated groove 230, an elongated protrusion can be provided with for example a T-shaped or L-shaped cross section where the mating element grips the T-shaped or L-shaped protrusion for locking in a similar way.

FIG. 2d illustrates a hook element 240 extending from the connective element. The hook element 240 can thus interact with a corresponding recess in the mating furniture element for locking in one or more directions, i.e. other directions than that where the hook element 240 unhooks. Alternatively, the connective element comprises a recess for receiving such a hook, and the locking is performed in a similar way.

FIG. 2e illustrates a bore 250 in the connective element for receiving a male member of a mating furniture element can be inserted. When the male member of the mating furniture is inserted into the bore 250, a locking means 252 can lock the male member in a direction along the bore 250 and lock the male member in a direction along the bore 250. The locking means 252 can be threads in the bore 250 and corresponding threads on the male member, be a pinching member engaging at least one side of the male member, or be expansion means of the male member engaging the bore 250. The locking means 252 can also be a tight fit between the male member and the bore 250, a wedged self-tightening fit, or a snap fit. Alternatively, the male member is arranged on the connective element and the mating furniture element has the bore, but the locking is performed similarly.

FIG. 2f illustrates a male member 260 arranged to engage a snap lock. The male member preferably has a recess 262 in which a resilient element inside the snap lock can lock, such that when the male member 260 is inserted into a slot of a snap lock of a mating furniture element, the resilient element snaps into the recess 262 of the male member 260 and locks the male member in the snap lock.

FIGS. 3a to 3f illustrate similar connecting means as FIGS. 2a to 2f, respectively, but where the connecting means are arranged essentially in a perpendicular direction to those of FIGS. 2a to 2f. The features and alternatives are otherwise the same as demonstrated with reference to FIGS. 2a to 2f.

It should be understood that combinations of connecting means as those demonstrated with reference to FIGS. 2a to 2f, 3a to 3f, i.e. in different directions and having different engaging features, and with the demonstrated available alternatives, are feasible and should be chosen for the particular design and desired features of the furniture element, for example as illustrated in FIG. 4.

The demonstrated approach has the further advantage that the connective element can be pre-formed with desired features and with desired accuracy in the connections, which implies improved speed, accuracy and reliability and thus yield in the production of the actual furniture elements. A further advantage is that, since the connective element is integrated into the furniture element at production, strength of joint between the connective element and the rest of the furniture element can be improved or at least more predictable, which also implies higher product quality.

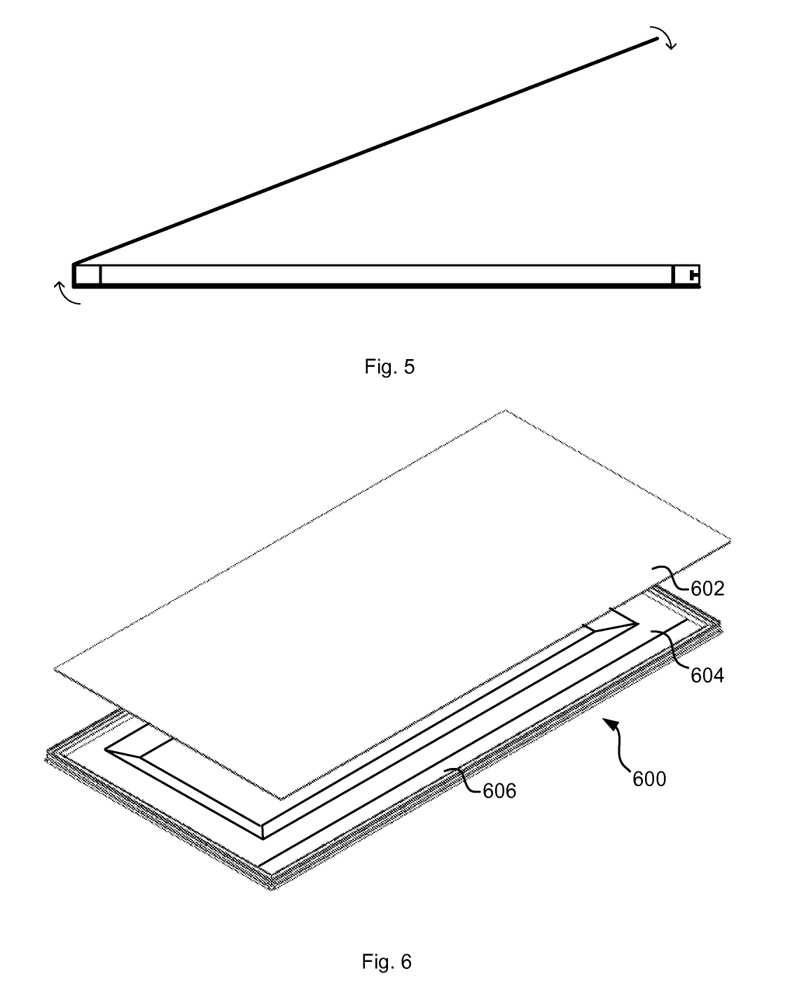

The embodiment demonstrated with reference to FIG. 1 is based on the approach that two separate and essentially planar sheets are joined with the connective element and possible further frame elements. Here, further elements such as a honeycomb distance material can also be provided between the sheets at areas where no frame elements or connective elements are provided to improve strength, form stability, and quality feeling of the furniture element. The distance material is preferably arranged such that it extends from the inner surface of the first sheet to the inner surface of the second sheet, and is preferably adhered to the inner surfaces of the sheets, e.g. by an adhesive or by welding. As an alternative, the two sheets can be formed from one sheet being folded around the connective element, and the possible frame elements and distance material, as illustrated in FIG. 5. This can be achieved by a supporting structure, i.e. the connective element, and the possible frame elements and fill material, being arranged on one of the one sheet, e.g. by means of an adhesive or by welding. The above referenced first and second sheets are then formed from the one sheet by folding by one or more folds such that the supporting structure is enclosed at least partly within the sheet. The one sheet can comprise a laminated board comprising a laminating foil. The laminating foil is applied on a first side of a board material on which a first longitudinal groove on the first side of the board material is applied, such that at least one outer-pointing normal to the tangent plane of each groove surface of the first groove will intersect the plane of the first side of the board. A second longitudinal groove on a second side of the board material is preferably also arranged, such that the second groove is extending through said board material to connect with said first groove, whereby a through slot is created in the board material, such that at least one outer-pointing normal to the tangent plane of each groove surface of the second groove will intersect the plane of the second side of the board, and the laminating foil covers the first groove, such that the one or more folds are along a set of such through slots. Thereby, the laminating foil will form an outer surface of the furniture element. By the two grooves, the folding corners will have a nice appearance, and the laminating foil will not be stressed at the folding. After the folding, the one sheet will be adhered and positioned similar to the approach where two separate sheets are used.

FIG. 6 is an exploded view of a furniture element 600 according to an embodiment. The furniture element 600 comprises a first sheet 602 of board material, a second sheet 604 of board material and a connective element 606. In this embodiment, at least one of the sheets is formed in a three-dimensional pattern, and the sheets are joined at their edges. Thus, the furniture element 600 need not comprise any frame elements since stability can be achieved by the three-dimensional sheet(s). The three-dimensional pattern can for example include a levelling difference along edges positioned at some distance from them, and a central levelling difference which may be arranged such that a at least a part of the central region of the sheet meets the other sheet when assembled (not shown). The parts where the sheets meet in the central region can be adhered to each other. The board material of the first and second sheets can be medium or high density fibreboard, which can be provided by for example a laminated surface element which will constitute an outer surface of the sheets in the final furniture element.

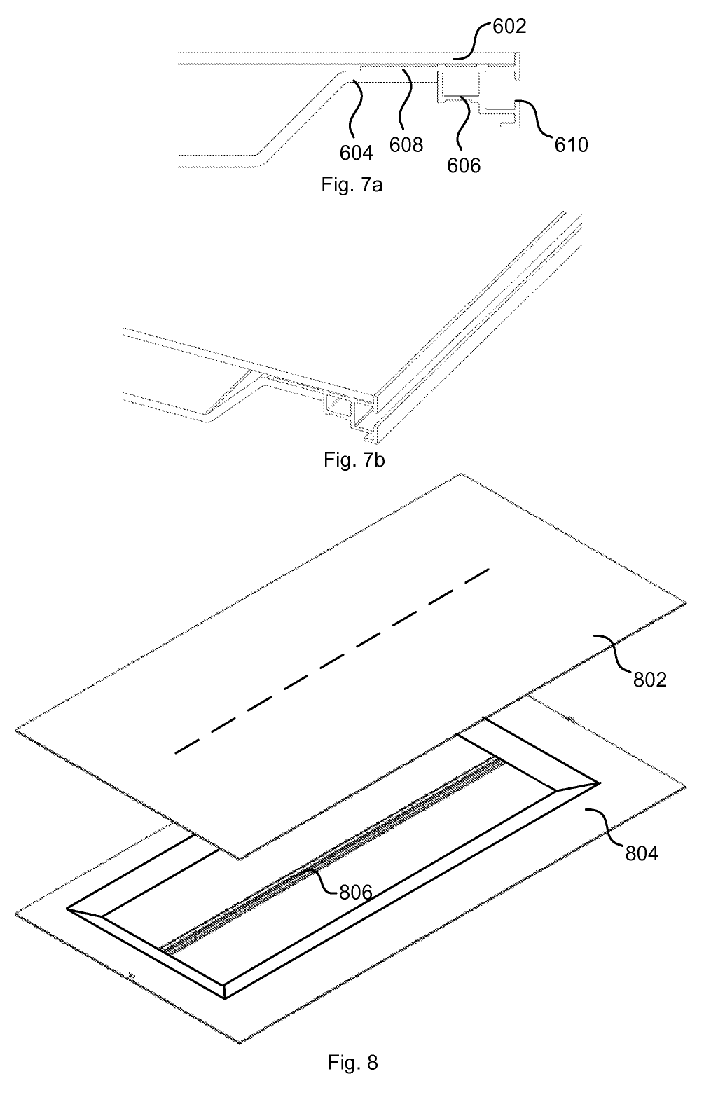

The connective element 606 has a part 608 of it provided between the sheets 602, 604 to be rigidly integrated, while another part 610 preferably is located outside the joint between the sheets 602,604 and is holding the connective means, as illustrated in FIGS. 7a and 7b. The connective means can be similar to any of the examples demonstrated above.

FIG. 8 is an exploded view of a furniture element 800 according to an embodiment. The furniture element 800 comprises a first sheet 802 of board material, a second sheet 804 of board material and a connective element 806. In this embodiment, as in the embodiment demonstrated with reference to FIG. 6, at least one of the sheets is formed in a three-dimensional pattern, and the sheets 802, 804 are joined at their edges. Thus, the furniture element 800 need not comprise any frame elements since stability can be achieved by the three-dimensional sheet(s). In this embodiment, the connective element 806 is arranged distant from any of the edges and is arranged to connect through the surface of at least one of the sheets. The connective means of the connective element 806 can be like any of the examples demonstrated above with reference to FIGS. 2 and 3.

For any of the embodiments demonstrated with reference to FIGS. 6 and 8, additional features as those demonstrated with reference to FIG. 1 can be provided, i.e. providing additional elements, distance material, welding or adhesive, combinations, positions and directions for connective means, etc for supporting the structure, function and appearance of the furniture element.

The above demonstrated principles can be embodied in numerous ways. For example, the furniture element can comprise a number of connective elements that have different features in any suitable configuration for the purpose of the furniture element. For example, a first connective element can be formed and arranged to reach in more than one direction and be arranged to provide connective means in two or more directions. A second connective element can have a part thereof that is arranged distant from any edge of the sheets, and simultaneously having another part arranged at the edge of the sheets. A third connective element can have only a part arranged between the sheets while a part protrudes from the edge of the sheets.

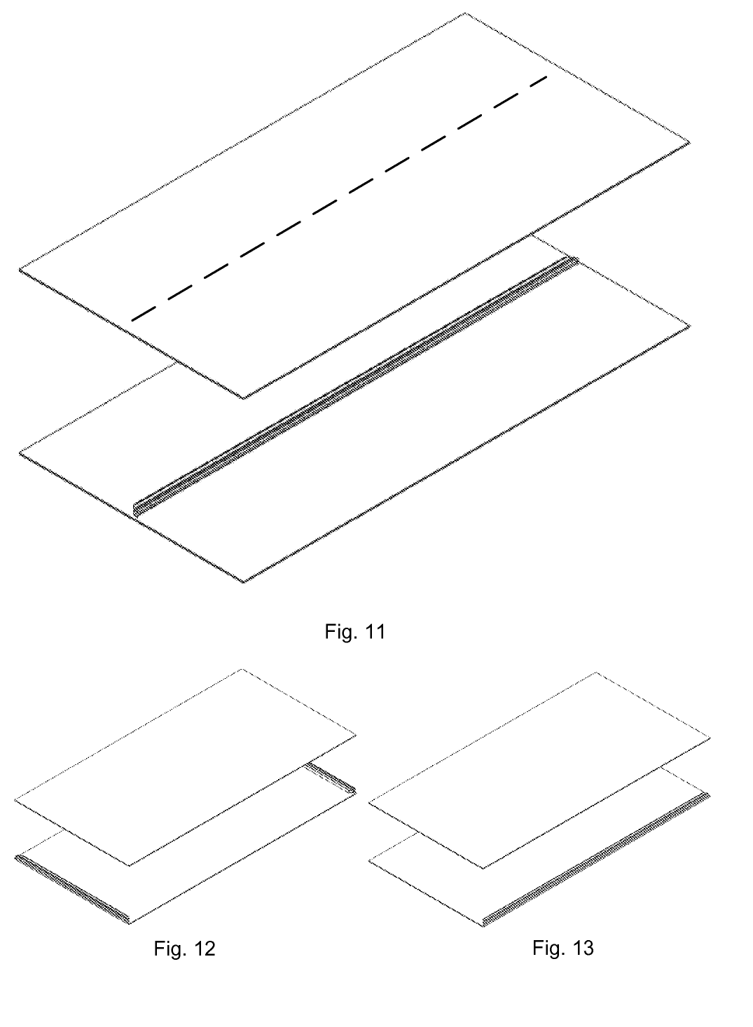

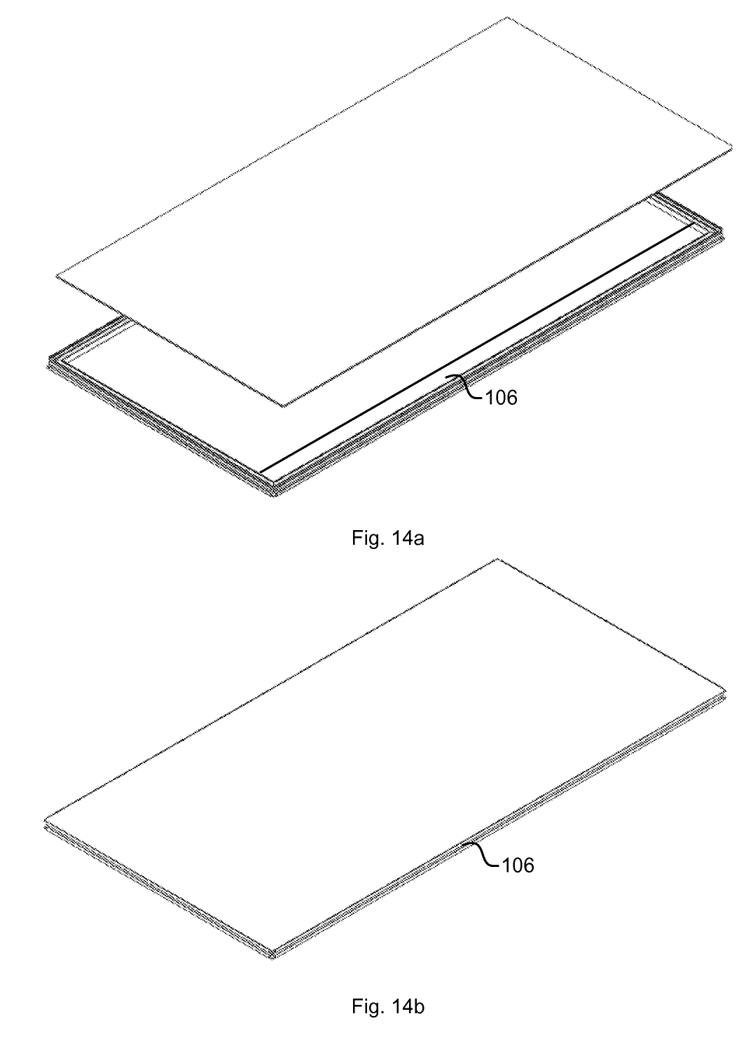

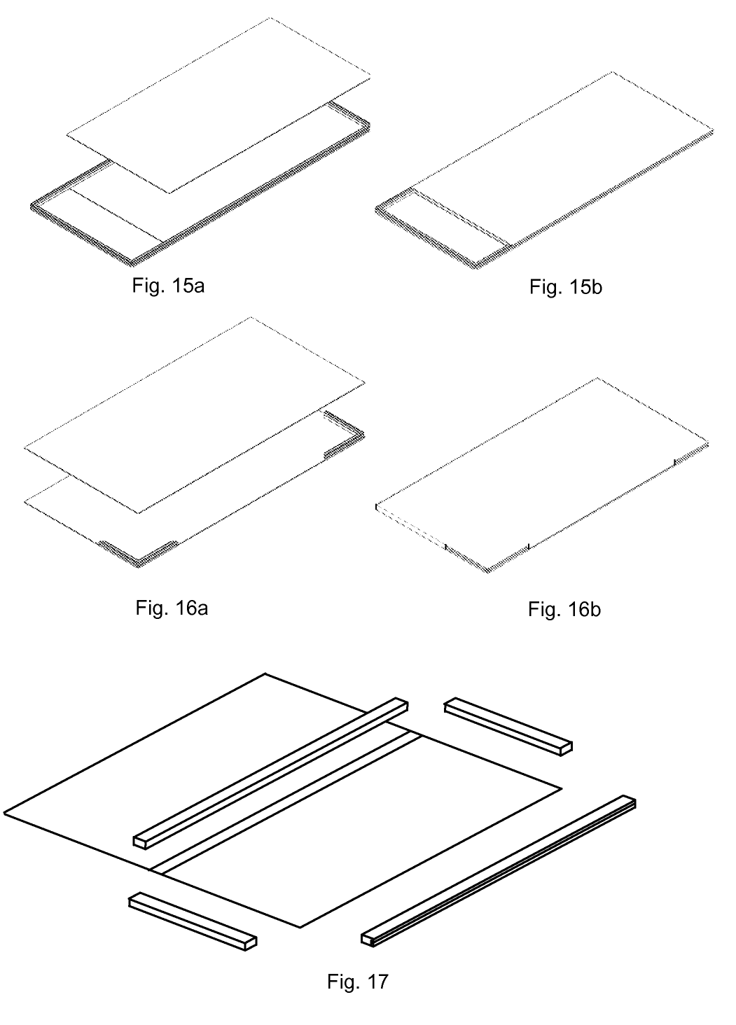

FIGS. 11 to 16 briefly illustrate a few of possible embodiments according to the above demonstrated principles. With reference to the embodiments demonstrated in FIGS. 1 and 8, a connective element arranged distant from edges can also be provided together with a frame as is illustrated in FIG. 11. FIG. 12 illustrates a furniture element where connective elements are provided along two edges, for example opposite edges. By providing connective elements along opposite edges, a modular building structure is enabled where similar type of furniture elements can be added to achieve desired size of furniture. FIG. 13 illustrates provision of a connective element along only one edge of a furniture element. This can be used for furniture where the connective element for example is arranged in a direction essentially invisible to a user when in use, but still enabling to connect functions, for example lighting device, cable holder, etc. FIG. 14a illustrates an embodiment similar to the one demonstrated with reference to FIG. 1 with connective and frame elements applied to one of the sheets, and FIG. 14b illustrates the furniture element of FIG. 14a assembled. FIG. 15a illustrates an embodiment where connective elements are provided also on a particular area of the furniture element. This is achieved by the sheets not having the same size. The dedicated connective area can be used for particular functions such as attachment of lighting equipment, screen for division or video rendering, working gear, electronics or electrical equipment for providing functions for the furniture or associated to use of the furniture, etc. FIG. 15b illustrates the furniture element of FIG. 15a in an assembled state. FIG. 16a illustrates a furniture element where connective element has functions on more than one direction, i.e. arranged at a corner of the furniture element. FIG. 16b illustrates the furniture element of FIG. 16a in an assembled state.

FIG. 17 illustrates elements in exploded view of a furniture element to be manufactured according to the principle demonstrated with reference to FIG. 5 above. It should be noted that a filling material (not shown), such as a honeycomb, welled, or other lightweight filler, can also be provided.

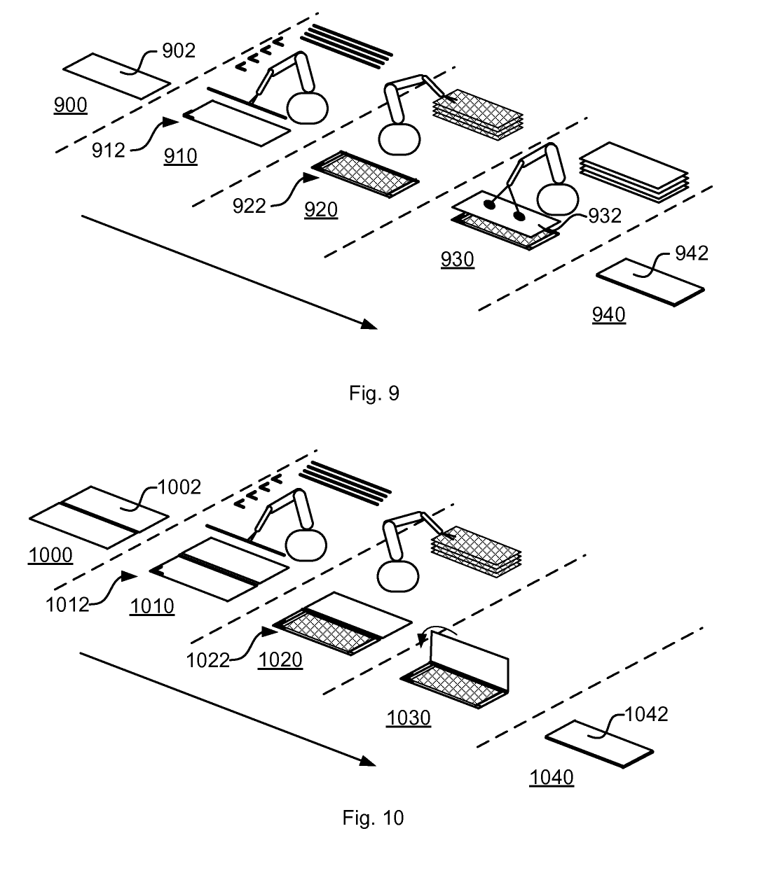

FIG. 9 schematically illustrates manufacturing of a furniture element according to an embodiment. The illustrations can be considered as a production line, but for the sake of clarity, most of the necessary equipment normally required for production of furniture elements are not shown since they would obscure the particulars of the way of manufacturing.

In a first step 900, a first sheet 902 is provided on the production line. The sheet 902 can be according to what has been disclosed in any of the embodiments dealing with separate first and second sheets above. The first sheet 902 is moved on to next step 910 where one or more connective elements 912 are positioned on the first sheet 902. The positioning is preferably performed in an automated way, e.g. by an industrial robot or a special purpose element dispenser. For the case where frame elements and/or distance material 922 are used, that is provided in a similar way in the optional step 920. Here, it should be noted that steps 910 and 920 can be made in the opposite order, or be made simultaneously in a joint step.

In step 930, a second sheet 932 is provided such that at least a part of (each of) the connective element (s) 912 and the optional frame elements and/or distance material 922 are enclosed between the first and second sheets 902, 932. In step 940, an assembled furniture element 942 is preferably pressed together and adhesion is finished. Any additional finishing, such as cutting, milling, drilling, provision of edges, paint, coating, etc., packaging, etc. may also be performed in further step(s).

FIG. 10 schematically illustrates manufacturing of a furniture element according to an embodiment. The illustrations can be considered as a production line, but for the sake of clarity, most of the necessary equipment normally required for production of furniture elements are not shown since they would obscure the particulars of the way of manufacturing.

In a first step 1000, a sheet 1002, which is preferably prepared for folding as demonstrated above, is provided on the production line. The sheet 1002 is moved on to next step 1010 where one or more connective elements 1012, and optionally to an optional step 1020 where frame elements and/or distance material 1022, are positioned on the sheet 1002. The positioning is preferably performed in an automated way, e.g. by an industrial robot or a special purpose element dispenser.

In step 1030, the sheet 1002 is folded such that at least a part of (each of) the connective element (s) 1012 and the optional frame elements and/or distance material 1022 are enclosed within the sheet 1002. In step 1040, an assembled furniture element 1042 is preferably pressed together and adhesion is finished. Any additional finishing, such as cutting, milling, drilling, provision of edges, paint, coating, etc., packaging, etc. may also be performed in further step(s).

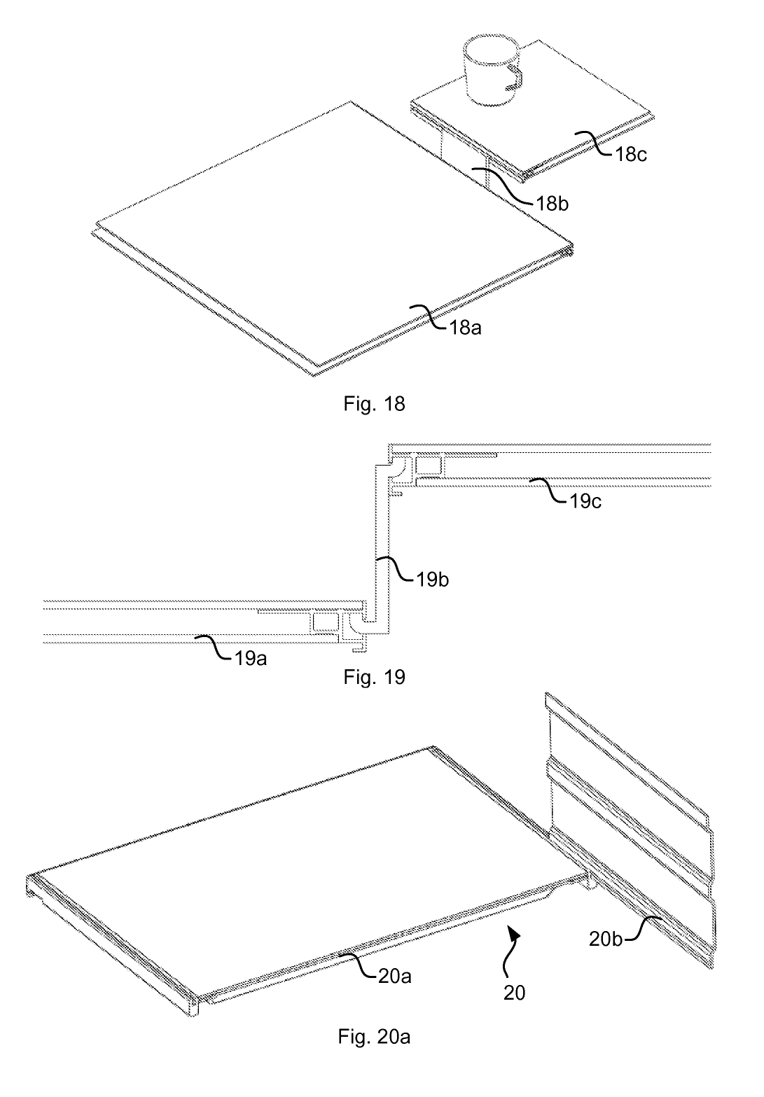

A number of use cases will be demonstrated with reference to FIGS. 18 to 24 to illustrate the versatility of the invented concept. Numerous of variants are possible, which will be understood by the artisan upon review of the given examples in this disclosure. Evidently, not all such variants can be explicitly disclosed herein, but the examples demonstrated below aim to give principles and examples such that the artisan is able to perform the invention in any of its many versatile possibilities.

FIG. 18 illustrates a use case where furniture elements 18a, 18b, 18c are connected according to an embodiment. A table 18a having connective element can for example be joined therethrough with a distance member 18b, e.g. made of a different material such as reinforced polymer or metal, such as aluminium or sheet iron, which in turn is joined with a further table or shelf element 18c having similar connective elements. The distance member 18b can be arranged to enable different levels between the table 18a and the further table or shelf element 18c. The weight of the elements 18b, 18c will keep the elements 18a, 18b, 18c locked together in use, as can be seen in FIG. 19, which illustrates a detail of such a connection. Elements 19a, 19b and 19c can be equal to elements 18a, 18b, 18c described with reference to FIG. 18, but can also be other types of furniture elements that needs to be joined together.

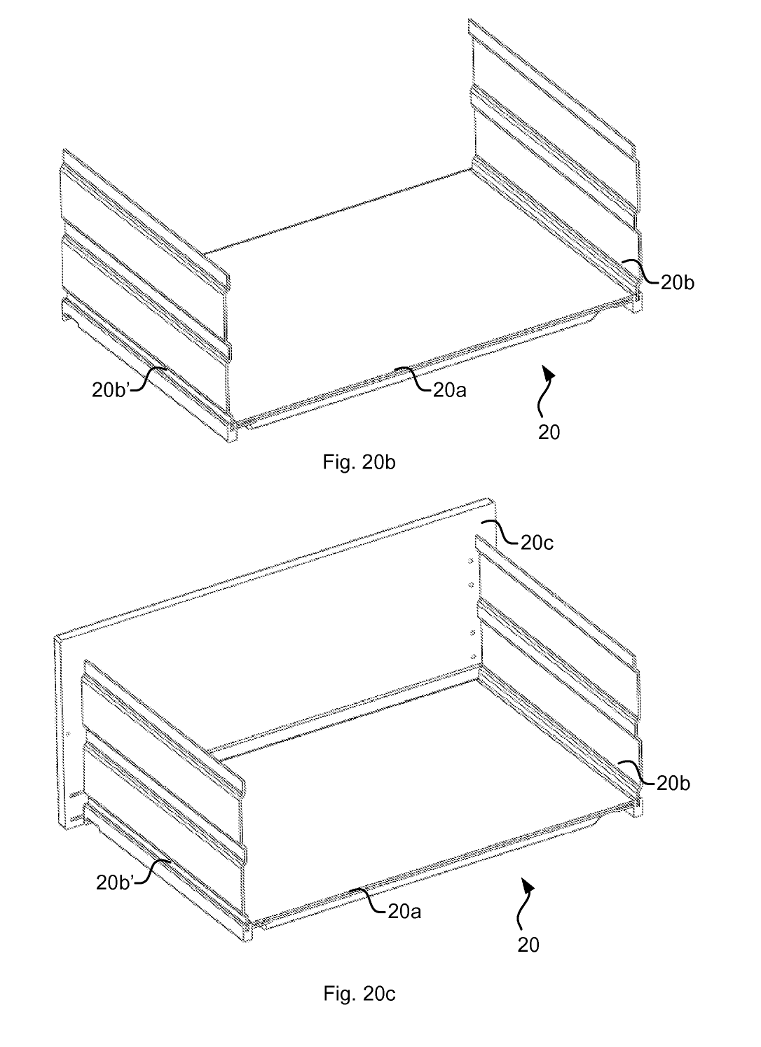

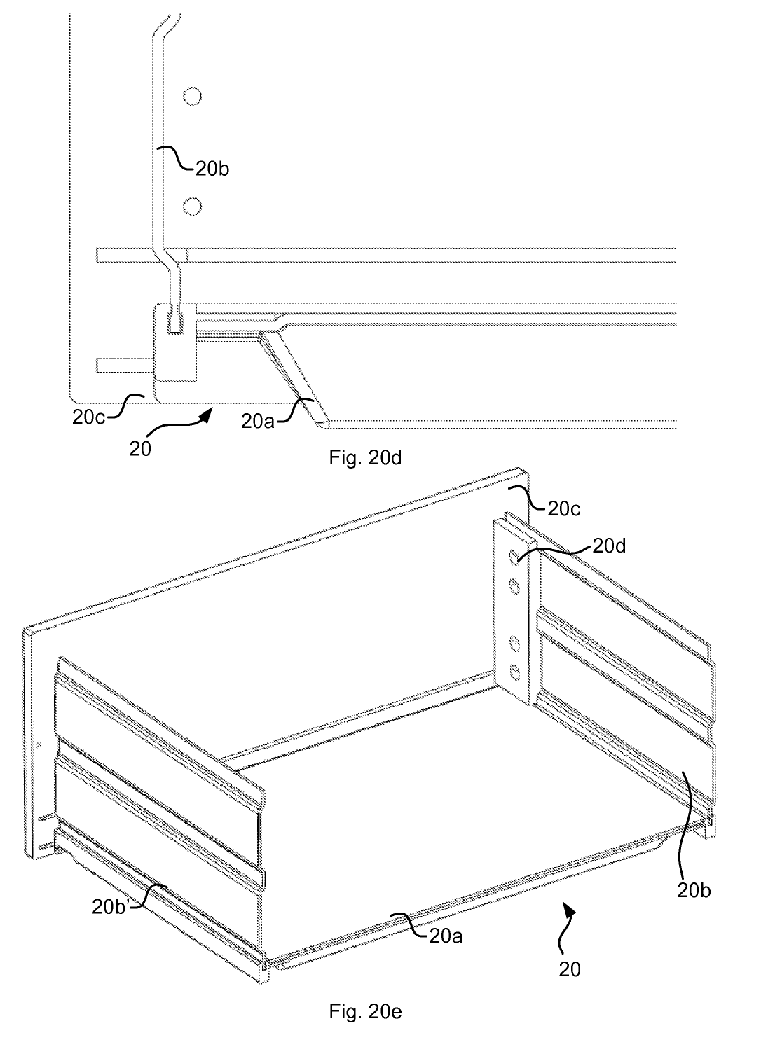

FIGS. 20a to 20e illustrate a use case where furniture elements are connected to form a drawer 20 according to an embodiment. In FIG. 20a, a bottom part 20a having connective elements is joined with a side piece 20b which is inserted into the connective element, as is also illustrated in FIG. 20d. FIG. 20b illustrates side pieces 20b, 20b′ joined with the bottom part 20a. For illustrating finishing a drawer 20, FIG. 20c illustrates a front panel 20c that is mounted by joining with connective elements of the bottom part 20a, and FIG. 20e illustrates further elements 20d for joining the side panels 20b, 20b′ to the front panel 20c.

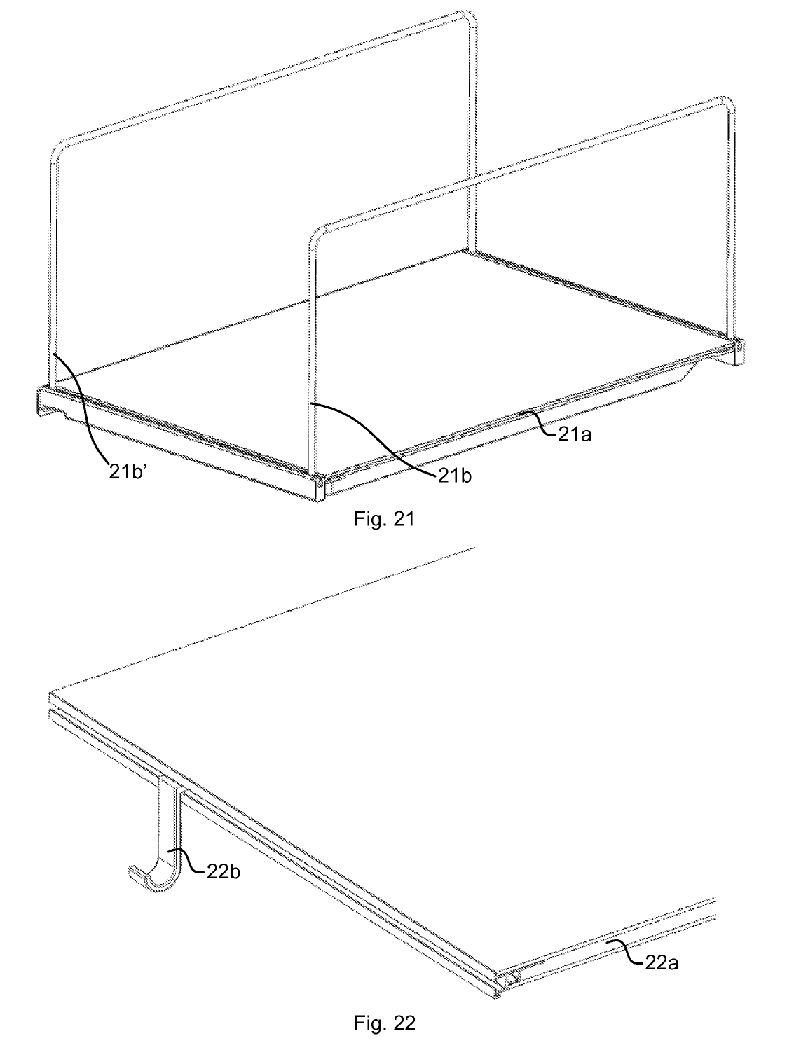

FIG. 21 illustrates a use case where furniture elements are connected to form a file cabinet 21 according to an embodiment. A bottom part 21a has connective elements arranged along at least two of its sides. Frames 21b, 21b′ are arranged to accommodate files of suspension type, and are joined with the connective elements to form the file cabinet 21.

For the drawer 20 demonstrated with reference to FIG. 20 and the file cabinet 21 demonstrated with reference to FIG. 21 can preferably be arranged on rails for enabling the drawer/file cabinet to be pulled out from and pushed in to a structure holding one or more drawers/file cabinets. These rails can also be arranged to mate connective elements of the bottom part.

FIG. 22 illustrates a use case where a furniture element 22a is connected to another furniture element 22b, here a hook, adapted for direct connection according to an embodiment. Other examples can be holders for cables, mail boxes, operator boxes for control of furniture lifting equipment, or other items that may occur in for example an office environment for the case the furniture is intended to be used in such environment.

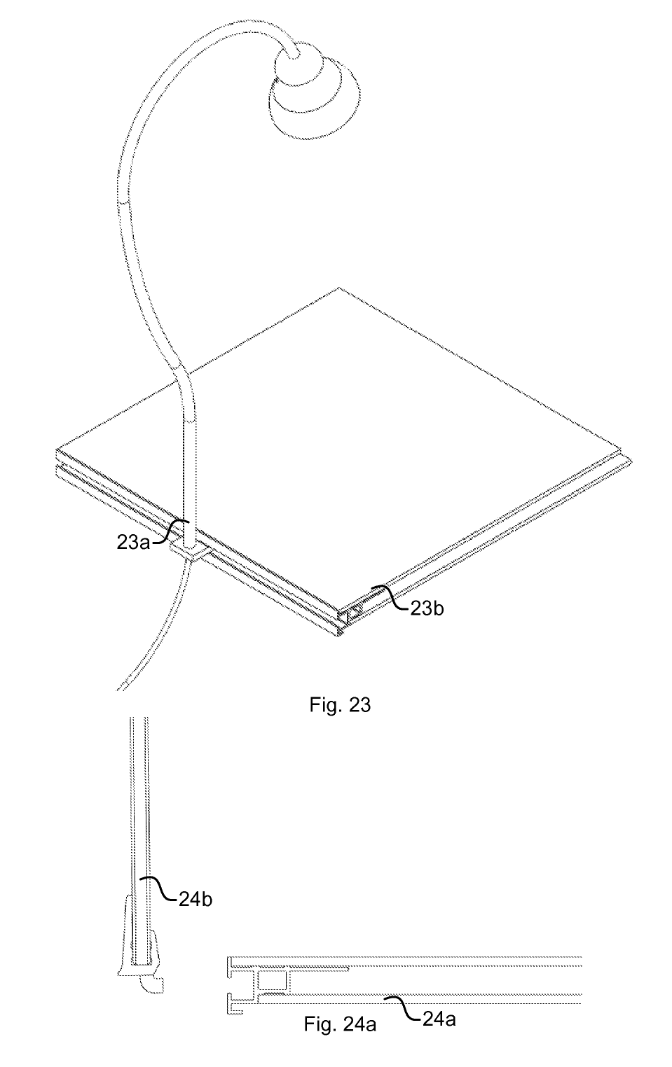

FIG. 23 illustrates a use case where a functional element 23a, here illustrated as a lighting device, is connected to a furniture element 23b according to an embodiment. Further examples of functional elements can be a screen holder, desktop computer compartment, holder for network or telecommunication equipment, or other equipment that can be desired to attach to furniture.

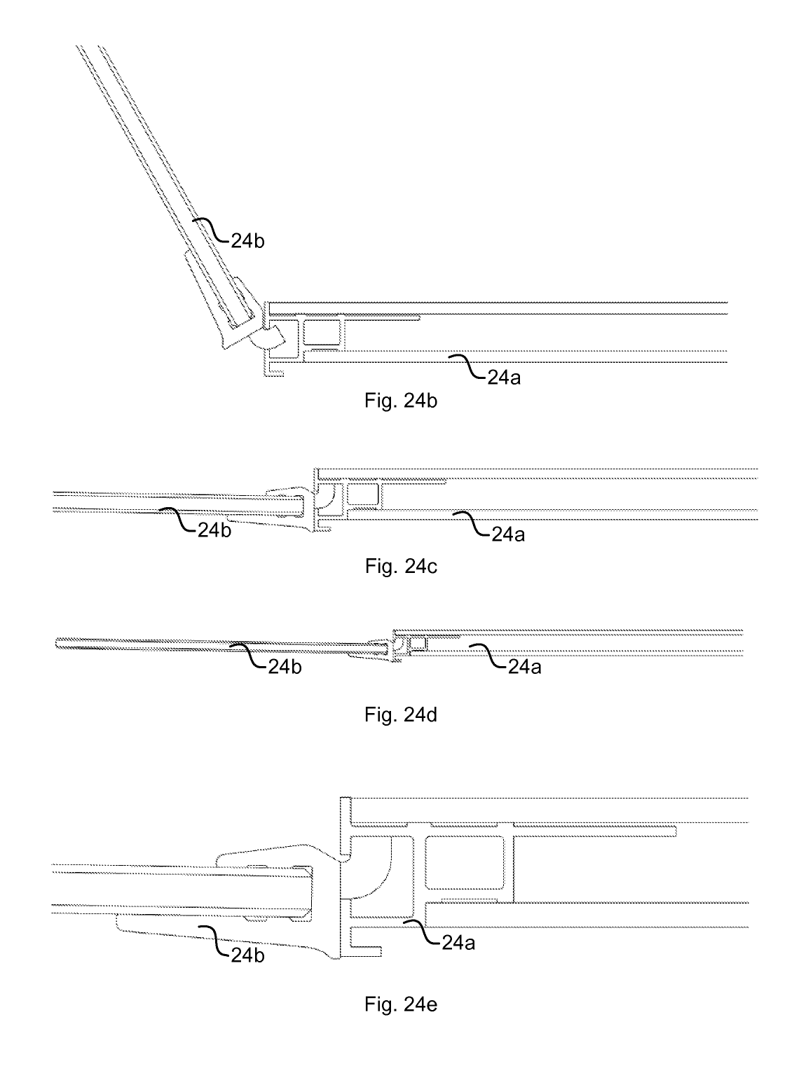

FIGS. 24a to 24e illustrate a use case where a furniture element 24a is connected to another furniture element 24b, here a shelf, adapted for direct connection to connective elements of the furniture element 24a. FIG. 24a illustrates the furniture elements 24a, 24b before joining them. FIG. 24b illustrates insertion of the another furniture element 24b into the connective element, and FIG. 24c illustrates the another furniture element 24b turned into position for locking with the connective element. FIG. 24d illustrates the another furniture element 24b when connected. The another furniture element 24b can also be an extension to the furniture element 24a, which can be a table. FIG. 24e illustrates the joint between the furniture elements 24a, 24b when in a locked position. Here, it can be seen that the locking is achieved by the weight of the another furniture element 24b.

1. A furniture element comprising
a first sheet of board material;
a second sheet of board material arranged with the first sheet to form a
structure of the furniture element, the furniture element being
characterised by
a connective element having at least a part thereof arranged between the first and second sheet material such that when, arranging the first sheet, the second sheet and the connective element, the first sheet, the second sheet and the connective element become integral parts of the furniture element, and the connective element being arranged to receive mating connective elements for connection of remote furniture elements.

2. The furniture element according to claim 1, further comprising
a supporting structure arranged on one of said sheets by means of an adhesive, wherein said first and second sheets is formed from one sheet which is folded by one or more folds such that the supporting structure is enclosed at least partly within said sheets.

3. The furniture element according to claim 2, wherein the connective element form at least a part of the supporting structure.

4. The furniture element according to claim 2 or 3, wherein said one sheet comprises a laminated board comprising
a laminating foil, applied on a first side of a board material on which a first longitudinal groove on said first side of the board material is applied, such that at least one outer-pointing normal to the tangent plane of each groove surface of the first groove will intersect the plane of the first side of the board, and a second longitudinal groove on a second side of said board material is arranged, such that said second groove is extending through said board material to connect with said first groove, whereby a through slot is created in the board material, such that at least one outer-pointing normal to the tangent plane of each groove surface of said second groove will intersect the plane of the second side of the board, and the laminating foil covers said first groove, such that the one or more folds are along a set of such through slots.

5. The furniture element according to any of claims 2 to 4, wherein said supporting structure comprises a longitudinal body at least along one edge of the furniture element.

6. The furniture element according to claim 5, wherein the longitudinal body is the connective element.

7. The furniture element according to any of claims 2 to 6, further comprising a distance material arranged between the first and second sheets.

8. The furniture element according to claim 7, wherein said distance material comprises honeycomb cardboard.

9. The furniture element according to claim 1, wherein the first and second sheets are adhered to each other along the edges thereof, and the cross-section of at least one of the sheets, in the normal to is, is provided with fluctuations, whereby a flexural rigidity of the furniture element is obtained.

10. The furniture element according to claim 9, wherein said connective element is arranged along at least a part of one of said edges and the part of the connective element being arranged between the first and second sheets is also adhered to the first and second sheets along the at least a part of the edge.

11. The furniture element according to any of claims 1 to 10, wherein at least a part of the connective element is arranged distant from any edge of the first or second sheet.

12. The furniture element according to claim 11, wherein the least a part of the connective element arranged distant from any edge of the first or second sheet is also arranged as a support between the first and second sheets.

13. The furniture element according to claim 11 or 12, wherein the least a part of the connective element arranged distant from any edge of the first or second sheet is arranged to connect to a remote furniture element such that a force component in a direction normal or counter-normal to at least one of the sheets is taken by the connection.

14. The furniture element according to any of claims 1 to 13, wherein at least a part of the connective element is arranged at an edge of the furniture element.

15. The furniture element according to claim 14, wherein the least a part of the connective element arranged at the edge of the furniture element is arranged to connect to a remote furniture element such that a force component in a direction perpendicular to a normal or counter-normal to at least one of the sheets is taken by the connection.

16. The furniture element according to claim 14 or 15, wherein the least a part of the connective element arranged at the edge of the furniture element is arranged to connect to a remote furniture element such that a force component in a direction normal or counter-normal to at least one of the sheets is taken by the connection.

17. The furniture element according to any of claims 1 to 16, wherein the connective element comprises any of a group comprising snap lock, bayonet lock, bolt receiver, and hook element.

18. A method of manufacturing a furniture element comprising
providing a first sheet of board material to a line of production;
providing on the first sheet, a connective element arranged to receive mating connective elements for connection of remote furniture elements;
enclosing the at least a part of the connective element by a second sheet of board material such that the at least a part of the connective element is arranged between the first and second sheet material such that when, arranging the first sheet, the second sheet and the connective element, the first sheet, the second sheet and the connective element become integral parts of the furniture element.

19. The method according to claim 18, wherein the first and second sheets are separate sheets.

20. The method according to claim 18, further comprising
forming said first and second sheets from one sheet by folding by one or more folds such that the step of enclosing of the at least part of the connective element is achieved within said first and second sheets.

21. The method according to claim 20, wherein said one sheet comprises a laminated board, the method further comprising
applying a first longitudinal groove on a first side of the board material such that at least one outer-pointing normal to the tangent plane of each groove surface of the first groove will intersect the plane of the first side of the board;
applying a second longitudinal groove on a second side of said board material is arranged, such that said second groove is extending through said board material to connect with said first groove, whereby a through slot is created in the board material and, such that at least one outer-pointing normal to the tangent plane of each groove surface of said second groove will intersect the plane of the second side of the board; and
applying a laminating foil on a first side of a board material such that the laminating foil covers said first groove,
wherein the one or more folds are made along a set of such through slots.

22. The method according to any of claims 18 to 21, further comprising
providing one or more members of a supporting structure arranged on said first sheet before said step of enclosing.

23. The method according to any of claims 18 to 22, further comprising adhering the connective element to the first and second sheets, respectively.
